(19) United States
(12) Patent Application Publication
(10) Pub. No.: US 2004/0183803 A1
(43) Pub. Date: Sep. 23, 2004

(54) System and method of creating a 360 degree movie animation of a vehicle

(76) Inventor: Robert J. Longo, Rocklin, CA (US)

Correspondence Address: Audrey A. Millemann, Weintraub Genshlea Chediak Sproul, 11th Floor, 400 Capitol Mall, Sacramento, CA, 95814, US

(21) Appl. No.: 10/800,088

(22) Filed: Mar. 12, 2004

Related U.S. Application Data
(60) Provisional application No. 60/454,621, filed on Mar. 17, 2003.

(51) Int. Cl. G06T 15/70

(52) U.S. Cl. 345/473

(57) ABSTRACT

The invention is a system and method of creating a 360 degree movie animation of a vehicle. The system includes a turntable for a vehicle, a digital camera, and a computer program. The method includes loading a vehicle on the turntable, using the digital camera to take a series of photographs of the vehicle at timed intervals (either through an interval shooting mode on the camera or switches on the turntable) as the turntable moves, and using software to create a 360 degree movie animation of the series of photographs. The movie animation may be delivered to a viewer over the Internet or on a CD.

### CROSS-REFERENCE TO RELATED APPLICATION

The present application claims the benefit of U.S. provisional patent application No. 60/454,621, filed Mar. 17, 2003 and entitled “Vehicle Turntable Photo System and Method for Taking Photos of a Vehicle That Can Be Manipulated to Allow a Computer Program With a User Interface to Spin the Car So the Vehicle Can Be Viewed From All Angles,” which is hereby incorporated by reference.

### BACKGROUND OF THE INVENTION

1. Field of the Invention

The invention relates generally to three-dimensional photography and animation and, in particular, to creating a movie animation of a vehicle.

2. Description of the Related Art

Virtual tours have become common on the internet today. Virtual tours of homes, resorts, and restaurants are available. Automobile manufacturers have made virtual tours or 360 degree views of new vehicles also available. The existing method is to set up a camera next to a stationary vehicle, move the camera around the vehicle while taking a series of photographs, and combine the photographs into an animation. A computer is then used to delete the background. This method is very expensive and time-consuming.

Thus, the vehicle sales market is in need of a method that will allow animated movies of vehicles to be taken in a quick and efficient manner.

### SUMMARY OF THE INVENTION

The system and method of the invention allow a 360 degree movie animation of a vehicle to be created in a quick and efficient fashion. The system and method of the invention are also more cost-effective than existing methods. By using the system and method of the invention, in one day, movie animations of one hundred vehicles can be created, in contrast to the existing method that allows only one movie animation of a single vehicle to be created. The system and method of the invention can be used in the sale of either new or used vehicles.

### BRIEF DESCRIPTION OF THE DRAWINGS

FIG. 1 is a diagram showing the components of the system and the flow of information in the method of one embodiment of the invention.

### DETAILED DESCRIPTION OF THE PREFERRED EMBODIMENTS

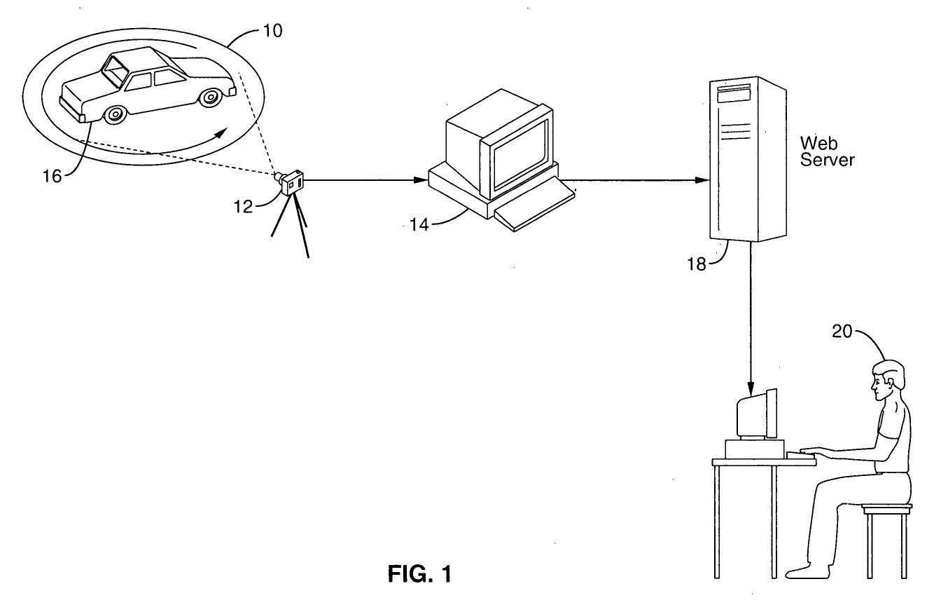

The system of the invention, as shown in FIG. 1, includes turntable 10, digital camera 12, and computer program 14. The system may also include a trailer, upon which turntable 10 is mounted.

Turntable 10 must be large enough to turn vehicle 16. Turntable 10 may be an above-pavement turntable, an elevated turntable, or a sub-pavement turntable. It should have a variable speed control and a switch that can stop the turntable after one revolution. An above-pavement turntable is a low-profile turntable that sits on a hard level surface. It is usually only a few inches high, and the vehicle is driven on to the turntable without a ramp. It is typically turned by a hydraulic pump. The above-pavement turntable is usually set up before each photography session and taken down after the session is completed. This type of turntable is preferable where many vehicles need to be photographed, such as a large automobile dealership. An above-pavement turntable may be obtained from CarTurn, Inc. in Aston, Pa.

An elevated turntable is about two to four feet high, and a removable ramp is used to drive the vehicle up on to the turntable. The elevated turntable can be mounted on a trailer and may consist of two ramps on a center support that is turned by a motor on the trailer. The elevated turntable is typically left in place, rather than set up and taken down for each photography session. The elevated turntable is preferable where a small number or vehicles need to be photographed, such as a small automobile dealership. An elevated turntable may be obtained from Car-O-Sell in Old Hickory, Tenn., or Modular Display Systems in Placentia, Calif.

A sub-pavement turntable is permanently built at or below the ground level. The turntable has large rollers that are turned by a motor. The sub-pavement turntable does not require the use of a ramp. The sub-pavement turntable is preferable where large vehicles, such as trucks, motorhomes, and boats, need to be photographed. A sub-pavement turntable may be obtained from Hovair Systems, Inc. in Kent, Wash.

Digital camera 12 is a digital camera that is preferably equipped with an interval shooting mode which allows the camera to be set to take a specific number of photographs at timed intervals, for example, one photograph every three seconds for one minute. The following digital cameras would work well: Pentax Optio 550, Minolta Dimage S414, and Nikon COOLPIX 3700.

Alternatively, digital camera 12 may not be equipped with an interval shooting mode, but instead, turntable 10 may include one or more switches that send a signal to digital camera 12 (via either a wireless transmitter or hard wire) to trigger digital camera 12 to take a photograph.

Computer program 14 is standard software that is used to create a movie animation from the digital photographs that have been taken. The following software would work well: Macromedia Fireworks, from Macromedia, Inc., San Francisco, Calif. Apple QuickTime, from Apple, Cupertino, Calif. and Ulead Gif Animator from Ulead Systems, Torrance. Calif.

The method of the invention includes the following steps, as shown in FIG. 1. Turntable 10 is preferably mounted in a stationary location, with a ramp if necessary, and is positioned to allow vehicle 16 to be driven onto turntable 10. Turntable 10 may be an above-pavement, elevated, or sub-pavement turntable, and may be powered by an electric motor or a hydraulic pump. If an elevated turntable is used, it may be mounted on a trailer. Turntable 10's variable speed control is set to turn vehicle 16 at a specific rate. It has been found that one revolution per minute works well, however, a faster or slower rate by be used, depending on the shooting speed of digital camera 12.

Digital camera 12 is mounted near turntable 10, either on a tripod or other stationary fixture. Digital camera 12 is preferably positioned about 15 feet away from turntable 10 and is directed toward the vehicle. Digital camera 12 is preferably equipped with an interval shooting mode that allows the camera to be set or programmed to take a specific, number of photographs at timed intervals for a particular length of time, preferably the time required for turntable 10 to complete one revolution. It has been found that a setting of one photograph every three seconds for one minute works well, resulting in 20 photographs for one revolution. A faster or slower rate may be used. If a faster rate is used, more than 20 photographs will be obtained. This will increase the size, and thus, the quality, of the movie animation, but will also increase the time required to deliver the animation over the Internet. If the movie animation is provided on a CD rather than over the Internet, however, then it would be advantageous to obtain more photographs.

Alternatively, if digital camera 12 is not equipped with an interval shooting mode, turntable 10 should include one or more switches to trigger digital camera 12 to take a photograph, via either a wireless transmitter or hard wire.

Vehicle 16 is loaded onto turntable 10. Vehicle 16 may be an automobile, truck, boat, motorcycle, motorhome, or other vehicle.

Turntable 10 begins to turn continuously and digital camera 12 begins to take a series of photographs. The timing of digital camera 12 and turntable 10 will result in a specific number of photographs being taken, as vehicle 16 is being turned, each from a different angle. Digital camera 12 preferably stops taking photographs when turntable 10 has completed one revolution, such that vehicle 16 will have been photographed from various points throughout its 360 degree revolution. This preferably results in a series of 20 photographs taken over the 360 degree revolution. 15 The photographs taken by digital camera 12 are uploaded to a computer programmed with computer program 14. Computer program 14 is software that uses the photographs to create an animation which will show vehicle 16 spinning, as if it were being viewed throughout its 360 degree revolution. The resulting movie animation can be stored in a file in a gif format, or any other format available for a movie animation.

The movie animation is then uploaded to web server 18 or written to a CD. Then the movie animation can be delivered to viewer 20 over the Internet or provided on a CD. Viewer 20 can spin the vehicle using their mouse or keyboard and can also zoom in and out of the animation to better view the details of vehicle 16.

The steps above are repeated for each vehicle for which a movie animation is to be created.

The invention has been described above with reference to the preferred embodiments. Those skilled in the art may envision other embodiments and variations of the invention that fall within the scope of the claims.

I claim:

1. A system for creating a movie animation of a vehicle, comprising:
a. a turntable for a vehicle;
b. a digital camera; and
c. a computer program for creating a movie animation from a series of photographs.

2. The system of claim 1, wherein said digital camera has an interval shooting mode.

3. The system of claim 1, wherein said turntable includes a switch to trigger said digital camera to take at least one photograph.

4. The system of claim 1, further including a trailer upon which said turntable can be mounted.

5. A method of creating a movie animation of a vehicle, comprising:
a. positioning a turntable for a vehicle;
b. loading said vehicle on said turntable;
c. positioning a digital camera near said turntable directed toward said vehicle;
d. turning said turntable continuously for one revolution, and simultaneously using said digital camera to take a series of photographs of said vehicle at timed intervals; and
e. using a computer program to create a movie animation of said vehicle from said series of photographs.

6. The method of claim 5, wherein said digital camera has an interval shooting mode, and further, wherein said interval shooting mode is set to take a series of photographs of said vehicle at timed intervals.

7. The method of claim 6, wherein said digital camera is set to take a photograph every three seconds for one minute, and further, wherein said turntable turns at the rate of one revolution per minute.

8. The method of claim 5, wherein said turntable includes a switch to trigger said digital camera to take said series of photographs.

9. The method of claim 8, wherein said switch is a wireless transmitter.

10. The method of claim 5, wherein said turntable is mounted on a trailer.
